(19) United States
(12) Patent Application Publication
(10) Pub. No.: US 2009/0277769 A1
(43) Pub. Date: Nov. 12, 2009

(54) Enhanced solar still

(76) Inventor: Claude Alan Nichols, Tucson, AZ (US)

Correspondence Address: Mark E. Ogram, Ste. 110-186, 6990 E. 22nd Street, Tucson, AZ, 85710-5192, US

(21) Appl. No.: 12/151,451

(22) Filed: May 6, 2008

(51) Int. Cl. C02F 1/14

(52) U.S. Cl. 202/234

(57) ABSTRACT

A water still having an evaporative chamber containing the liquid water. When the evaporative chamber subjected to solar provided heat the water vaporizes and then condenses on the condensing plate where the condensed water flows to a collection reservoir. The condensed water contacts solid essential minerals or precious metals to “re-mineralize” the condensed water. The condensed water is contained within the heated evaporative chamber to force suspended volatile gases to be exhausted from the water.

### BACKGROUND OF THE INVENTION

The present invention relates generally to solar stills and more particularly to solar stills used to produce drinkable water.

Solar distillation mechanisms have been in use since 1872 where they were put into use in Las Salina, Chile. The purpose of the solar still is to capitalize upon the solar heat to evaporate liquid water and then condense the vaporized water into a more pure form.

In more modern applications, there have been a number of design and operational advances, including, but not limited to: U.S. Pat. No. 7,264,695, entitled “Systems and Methods for Solar Distillation” issued to Foster et al. on Sep. 4, 2007; U.S. Pat. No. 7,153,395, entitled “Systems and Methods for Solar Distillation” issued to Foster et al. on Dec. 26, 2006; U.S. Pat. No. 6,797,124, entitled “Solar Distillation Unit” issued to Ludwig. on Sep. 28, 2004; U.S. Pat. No. 6,767,433, entitled “System and Method for Solar Distillation” issued to Foster et al. on Jul. 27, 2004; U.S. Pat. No. 5,628,879, entitled “Sun Actuated Automated Distillation Apparatus” issued to Woodruff on May 13, 1997; U.S. Pat. No. 4,856,281, entitled “Solar Power Plant and Still” issued to Taylor on Aug. 15, 1989; U.S. Pat. No. 7,008,515, entitled “Solar Water Still” issued to Husson, Jr. Et al. on Mar. 7, 2006; and, U.S. Pat. No. 6,821,395, entitled “Solar Stills of the Tilted Tray Type, for Producing Pure Drinking Water” issued to Ward on Nov. 23, 2004; U.S. Pat. No. 6,494,995, entitled “Solar Distillation System” issued to Battah on Dec. 17, 2002; all of which are incorporated hereinto by reference.

One handicap of a solar still is that, if it is working optimally, only pure distilled water is condensed; but, distilled water is not palatable and doesn't contain any of the required essential minerals for human life. On the other hand, if the solar still is not working optimally, the condensed water often includes undesirable substances such as hydrocarbons and chlorine.

Perhaps the most problematic problems with solar stills is the distilled water itself. Distilled water is extremely caustic to a wide variety of materials, including, but not limited to brass, copper, and even plastics. Because of this, it is impossible to pump the distilled water from a solar still through the traditional pipes within a dwelling.

It is clear there is a continuing need for improved solar stills to address the needs for clean drinkable water.

### SUMMARY OF THE INVENTION

In one embodiment of the present invention, an improved solar still or drinking water generator is created in which essential minerals are re-introduced to the condensed water.

Generally, the essential minerals consist of fourteen minerals that have been found to be essential to human health. They are: calcium, chromium, copper, fluorine, iodine, iron, magnesium, manganese, molybdenum, phosphorus, potassium, selenium, sodium and zinc. These essential minerals are crucial for proper growth and production of bones, teeth, hair, blood, nerves, skin, vitamins, enzymes and hormones. Further, the essential minerals are critical for the healthy functioning of nerve transmission, blood circulation, fluid regulation, cellular integrity, energy production and muscle contraction.

Large quantities (in the milligram levels) of calcium, iron, magnesium, phosphorus and zinc are required.

The solar still uses an evaporative chamber containing liquid water. The liquid water is introduced into the still through conventional methods and is positioned to optimize the evaporative process. In some embodiments of the invention, a fiberglass fabric is used to “wick” the water into thin sheets so that the water is encouraged to evaporate under the solar heat. In other embodiments, the water is caught in shallow troughs for the same purpose.

In some embodiments, the evaporative chamber is flat, in others, the preferred configuration, the evaporative chamber is sloped so that the evaporative chamber is substantially at right angles to the sun's rays.

The evaporative chamber is subjected to solar provided heat. This is done by using a clear member (such as glass, clear plastic, or the like) which allows the solar heat to enter and become trapped within the evaporative chamber.

This trapped heat encourages the liquid water to vaporize. In the vaporization process, contaminates within the water are left behind and only pure water is vaporized. This vaporized water is condensed onto a condensing plate. In the preferred embodiment, the condensing plate is the clear member itself. The clear member is cooled by the ambient conditions so that the vaporized water is condensed and drips/flows into a collection reservoir.

The condensed water contacts the selected essential minerals. This contact is done either during the flow/dripping of the condensed water on the condensing plate, or once the condensed water is collected within the collection reservoir.

This contact with the selected essential minerals “re-mineralizes” the previously distilled water so that the water is more palatable and healthy for the consumer while being less aggressive to the plumbing system within the house. Further, the re-mineralization process allows the water to be “enhanced” with either minerals that were heretofore non-existent in the original water or were in diminished amounts.

The invention even allows for non-typical elements/compounds to be easily added to the condensed water. This includes precious metals such as gold or silver.

In the preferred embodiment of the invention, the drinking water is further improved by maintaining the collection reservoir within the evaporative chamber. The condensed water within the collection reservoir (ideally having a capacity of one quart or more), is now “cooked” or heated to remove any volatile gases which might be suspended in the condensed water (such as chlorine). The volatile gases which have been discharged from the condensed water are exhausted into the ambient environment via a vent.

Ideally, the condensed water is treated to this temperature, of 160 degree Fahrenheit or more, for at least one hour to assure that the volatile gasses are removed sufficiently.

The invention, together with various embodiments thereof, will be more fully explained by the accompanying drawings and the following descriptions thereof.

### DRAWINGS IN BRIEF

FIG. 1 is an operational view of the preferred embodiment of the invention.

FIGS. 2A and 2B illustrate alternative embodiments of the invention.

FIGS. 3A, 3B and 3C illustrate alternative embodiments for the deposition of the precious metals or essential minerals.

FIG. 4 is a side view of an embodiment of the invention which permits easy re-charging of the essential minerals for the distilled water.

### DRAWINGS IN DETAIL

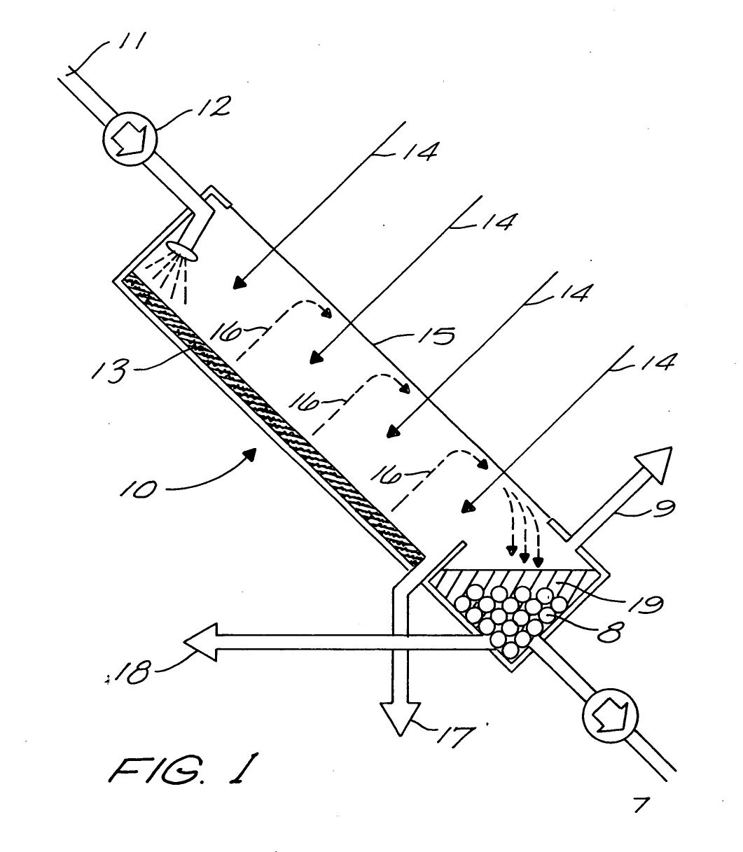

FIG. 1 is an operational view of the preferred embodiment of the invention.

Solar still 10, in this embodiment, is box shaped with a transparent surface 15 positioned to accept sunlight 14. As the sunlight 14 enters through the transparent surface 15, the interior of solar still 10 is heated.

Water 11 is deposited into the solar still 10 using a timed valve 12. The water is sprayed onto a wicking material 13, such as fiber glass fabric. The water permeates wicking material 13. Any excess liquid water is exhausted through drain 17.

As the interior of solar still 10 is heated using the sunlight 14, the liquid water on wicking material 13 evaporates, as indicated by arrows 16, and contacts the transparent surface 15 which acts as a condensing plate because transparent surface 15 is cooled by the ambient air.

The condensed water flows down the transparent surface 15 and is deposited into reservoir 19. Ideally reservoir 19 holds at least one quart of water and serves as the primary catch basin for all of the collected water.

The collected water within reservoir 19 is maintained within the solar still 10 and is subjected to the collected heat therein. This heating, ideally over 160 degrees Fahrenheit for a period of at least four hours, causes the suspended volatile gases to escape the condensed water and be exhausted to the atmosphere via vent 9.

In this embodiment, contained within reservoir 19 are granules of selected essential minerals or precious metals (such as silver or gold). The condensed water stored within reservoir 19 picks up these essential minerals or precious metals to create a better tasting and healthier water for the user.

This healthier water is communicated to the consumer via a pipe to the house.

In this manner, a healthy supply of purified and drinkable water is provided to the household.

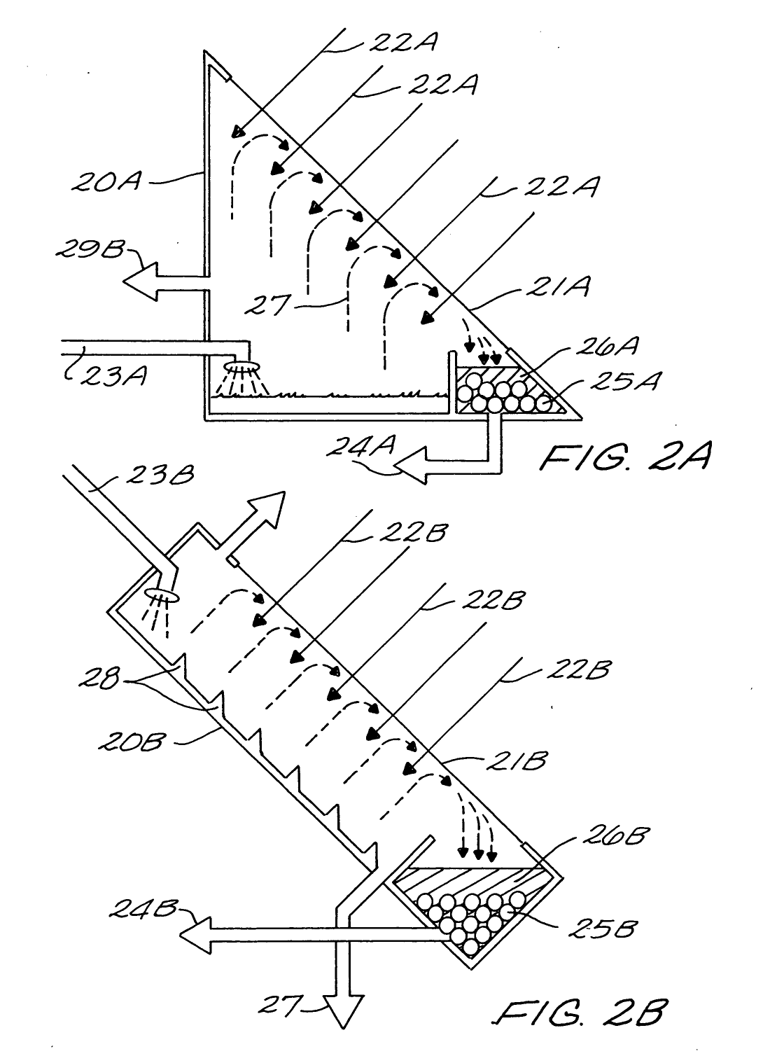

FIGS. 2A and 2B illustrate alternative embodiments of the invention.

The embodiment of FIG. 2A uses a solar still 20A which has a triangular cross section. Clear panel 21A allows sunlight 22A to penetrate and heat the interior of solar still 20A.

Liquid water 23A has been deposited into the bottom of solar still 20A and is evaporated using the heat from sunlight 22A. The evaporated water contacts clear panel 21A which condenses the vapor as indicated by arrows 27. The condensed water flows down clear panel 21A to be collected in reservoir 26A where the condensed water is treated by contacting the essential minerals 25A contained therein.

Ideally, the water within the reservoir is heated for an extended period of time (for one hour or more) to release the volatile gases contained therein. These released gases are exhausted into the atmosphere via vent 29B.

The purified water is then communicated to the consumer 24A.

FIG. 2B illustrates an embodiment of the invention which uses a rectangular solar still 20B. As before, a source of water 23B provides water to the solar still 20B. This water is deposited at the top of solar still 20B and flows downward and is caught in troughs 28. The excess water is drained 27.

The interior of solar still 20B is heated using sunlight 22B which enters via clear condensing panel 21B. The water caught in troughs 28 is evaporated and condensed as described earlier. The condensed water is collected in reservoir 26B and treated by essential minerals 25B.

The treated water is then drained to the user's consumption 24B.

FIGS. 3A and 3B illustrate alternative embodiments for the deposition of the precious metals or essential minerals.

Referring to FIG. 3A, the clear condensing panel 30A (used on any of the prior solar stills discussed) is equipped with a series of troughs 31A which cascade the condensed water downward.

In one embodiment, the troughs 31A themselves are made from the essential minerals so that the water, as it flows across each trough, picks up trace amounts of the essential mineral.

In another embodiment, the trace minerals are deposited onto the troughs 31A either in granule form or as solid pieces.

FIG. 3B illustrates another clear condensing panel 30B. In this embodiment, the essential minerals 31B, as pellets, are arranged in lines across the clear condensing panel 30B forcing the condensed water to “trickle” through the minerals on the water's passage to the reservoir. As before, when the condensed water contacts the essential minerals, trace amounts of the essential minerals are released into the condensed water.

Referring to FIG. 3C, an alternative embodiment for the deposition of the precious metals or essential minerals, condensed distilled water 34A, flows down condensing panel 30C into preliminary reservoir 33 where the distilled water is brought into contact with the precious metals or essential minerals 31C.

The now re-mineralized water flows out of preliminary reservoir 33 into the primary reservoir 34 as indicated by arrow 32B. It is from the primary reservoir that the now re-mineralized water is stored until introduced into plumbing system.

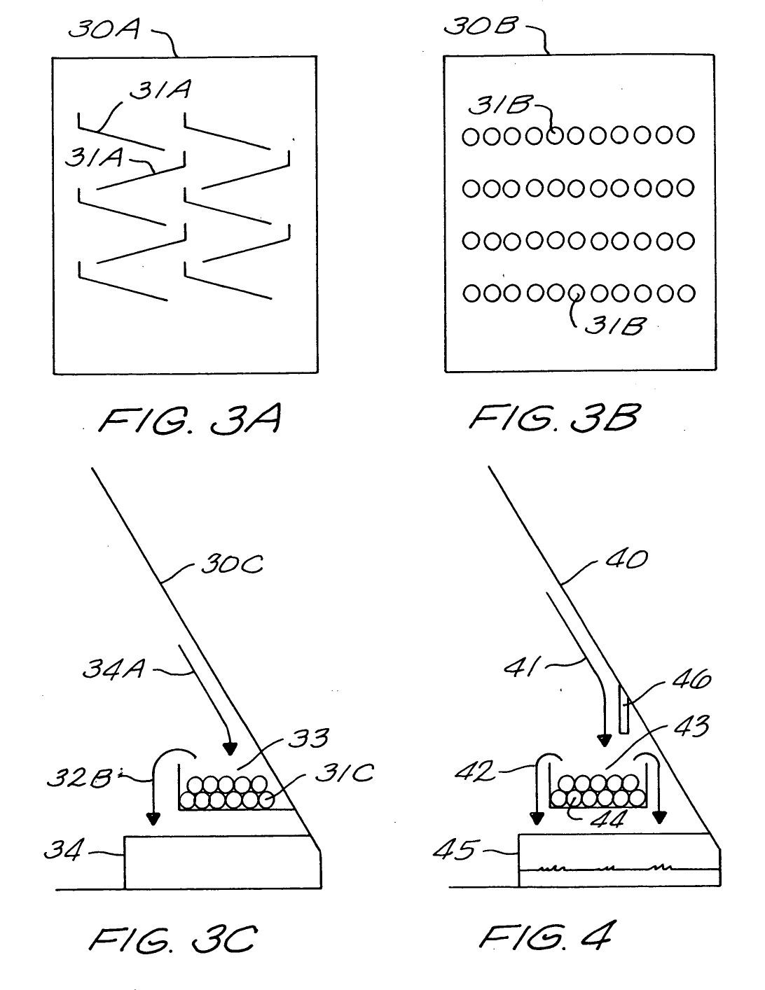

FIG. 4 is a side view of an embodiment of the invention which permits easy re-charging of the essential minerals for the distilled water.

As before, the distilled condensed water flows as indicated by arrow 41 down the condensing panel until it engages with deflector 46 where the distilled condensed water is directed into drawer 43 containing the solid precious metals or essential minerals 44

In this illustration the water eventually overflows from drawer 43 into the primary reservoir 45; in an alternative to this embodiment, the bottom of drawer 43 is porous allowing the re-mineralized water to trickle through to the primary reservoir 45.

Drawer 43 is removable from the solar still being pulled perpendicular to the plane of the drawing. By removing drawer 43, the essential minerals or precious metals 44 can be easily replaced.

It is clear that the present invention creates a highly improved solar still providing excellent drinking water.

What is claimed is:

1. An improved solar still comprising:
a) an evaporative chamber containing liquid water, said evaporative chamber subjected to solar provided heat to encourage said liquid water to vaporize and then condense onto an inclined condensing plate; and,
b) a collection reservoir positioned to collect condensed water from said inclined condensing plate, said collection reservoir contained within said evaporative chamber such that said condensed water is subjected to said solar provided heat for an extended period prior to extraction from said collection reservoir.

2. The improved solar still according to claim 1, wherein said extended period is at least four hours.

3. The improved solar still according to claim 2, wherein said solar provided heat creates a temperature within said evaporative chamber of at least 180 degrees Fahrenheit.

4. The improved solar still according to claim 3, wherein said collection reservoir has a capacity of at least one quart.

5. The improved solar still according to claim 4, further including a vent communicating between an interior of the evaporative chamber and an ambient environment.

6. The improved solar still according to claim 1,
a) further including selected essential minerals contained within said evaporative chamber; and,
b) wherein the condensed water contacts said selected essential minerals.

7. The improved solar still according to claim 6, wherein said selected essential minerals are contained within said collection reservoir.

8. The improved solar still according to claim 6,
a) further including at least two catch basins positioned on said inclined condensing plate; and,
b) wherein said selected essential minerals are contained within said at least two catch basins.

9. The improved solar still according to claim 6, further including precious metals contacting said condensed water.

10. A drinking water generator comprising:
a) an evaporative chamber containing liquid water, said evaporative chamber subjected to solar provided heat to encourage said liquid water to vaporize and then condense onto a condensing plate; and,
b) selected essential minerals contained within said evaporative chamber such that the condensed water contacts said selected essential minerals.

11. The drinking water generator according to claim 10, further including a collection reservoir positioned to collect condensed water from said inclined condensing plate, said collection reservoir contained within said evaporative chamber such that said condensed water in said collection reservoir is subjected to said solar provided heat for at least four hours prior to extraction from said collection reservoir.

12. The drinking water generator according to claim 11, wherein said selected essential minerals are contained within said collection reservoir.

13. The drinking water generator according to claim 10,
a) further including at least two catch basins positioned on said condensing plate; and,
b) wherein said selected essential minerals are contained within said at least two catch basins.

14. The drinking water generator according to claim 10, further including precious metals contacting said condensed water.

15. The drinking water generator according to claim 14, wherein said precious metals include gold.

16. The drinking water generator according to claim 10, further including a vent communicating between an interior of the evaporative chamber and an ambient environment.

17. A water still comprising:
a) an evaporative chamber containing liquid water, said evaporative chamber subjected to solar provided heat to encourage said liquid water to vaporize and then condense onto an inclined condensing plate;
b) a collection reservoir having a capacity of at least one quart and positioned to collect condensed water from said inclined condensing plate, said collection reservoir totally contained within said evaporative chamber such that said condensed water within said collection reservoir is subjected to said solar provided heat for at least four hours prior to extraction from said collection reservoir;
c) a vent communicating exhausted gasses from the condensed water to an ambient environment; and,
d) selected essential minerals contained within said evaporative chamber such that the condensed water contacts said selected essential minerals.

18. The water still according to claim 17, wherein said selected essential minerals are contained within said collection reservoir.

19. The water still according to claim 17,
a) further including a catch basin positioned on said inclined condensing plate; and,
b) wherein said selected essential minerals are contained within said catch basin.

20. The water still according to claim 17, further including precious metals contacting said condensed water.
